(19) United States
(12) Patent Application Publication
(10) Pub. No.: US 2021/0395064 A1
(43) Pub. Date: Dec. 23, 2021

(54) LATERAL-CUTTING CAN OPENER ASSEMBLY

(71) Applicant: Mr. Bar-B-Q Products LLC, Melville, NY (US)

(72) Inventors: Marc Zemel, Melville, NY (US); Joanne Rudis, Melville, NY (US)

(21) Appl. No.: 16/906,163

(22) Filed: Jun. 19, 2020

(51) Int. Cl. B67B 7/70; B67B 7/46

(52) U.S. Cl. CPC B67B 7/32; B67B 2007/303; B67B 7/34

(57) ABSTRACT

A lateral-cutting can opener assembly configured to pierce and make a continuous incision on a peripheral can wall or a peripheral rim wall. The lateral-cutting can opener assembly may include a first handle defining a distal portion and a proximal portion configured for grasping by a human hand, a second handle defining a central axis and including a gripping portion extending way from an anvil, a knife operably connected to the anvil and disposed at an inclination between 180 and 230 degrees relative to the central axis of the handle, a drive wheel configured to operably connect to the distal portion of the first handle and to operably connect the first handle to the second handle and including a shaft extending away from a drive wheel head. The first handle is configured to pivot relative to the second handle or the drive wheel.

### TECHNICAL FIELD

The present disclosure relates to devices and methods configured to open a can, such as a can opener. More particularly, the present disclosure relates to manually operable lateral cutting can opener assemblies configured to open a can laterally while making a clean cut around the peripheral wall of the can.

### BACKGROUND

Manually operable can openers, also known as tin openers, are mechanical devices generally used to open cans. Manually operable can openers have been known for many years and maybe roughly categorized into three types: a first type having a cutter blade which cuts directly into a can's top wall, a second type having a cutter blade which cuts into a can's side wall (e.g., below the rim), and a third type having a cutter blade which cuts partially into the rim of a can having a peripheral wall and ends joined by folding together edges of the wall and ends to form the rim. The second and third type are generally known as lateral-cutting can openers. A lateral-cutting can opener is a cutting tool able to laterally cut the rim or a side of a can, this may prevent the blade of the cutting tool from extending into the can to contaminate the food, while, the opening of the can avoids having any sharp points. Lateral-cutting can openers may provide a clean uniform, smooth cut around the peripheral side of the can ultimately enabling splitting of the can and reuse of the can lid, especially when an incision is made near the can's top wall. Thus, lateral-cutting can openers can be regarded as safe and hygienic for use while preserving the food with ease.

A typical can opener of the laterally cutting type generally comprises elements or parts operating connected to one another like an assembly. For example, one operating element may have a rotatable traction wheel or “drive wheel” generally opposite its handle and configured to feed a rim operably connected thereof, while the other operating element has a cutter blade or “knife” configured to engage a portion of the can (e.g., can sidewall). Can openers, which are configured to connect to the can, are generally known as can-holding openers, these can be of the laterally cutting type or the first or second type noted above and are configured to simultaneously grip the can and open it. Can-holding openers of the laterally cutting type may feature elements that would tightly grip a portion of the can (e.g., a can rim), for example, the feed wheel which may be serrated and may be configured to grip the rim of the can opener. In some can-holding openers, the feed wheel allows a firm grip of the can edge against the knife progressively cutting the lid along the rim, during rotation of a handle which is generally connected to the cutting wheel. However, most can-holding openers, particularly of the laterally cutting type, provide poor engagement of the can and may not facilitate easy manipulation of the can or the device itself. Besides, most can-holding openers of the later cutting type do not enable knife replacement. Thus, there is a need for devices and methods, such as can-holding openers of the laterally cutting type that may facilitate an easy manipulation and may allow knife replacement.

### SUMMARY

A lateral-cutting can opener assembly and method for engaging and lateral-cutting a can is provided.

Specifically, the present disclosure provides a lateral-cutting can opener assembly configured to pierce and make a continuous incision on a peripheral can wall or a peripheral rim wall. In aspects, the lateral-cutting can opener assembly includes a first handle defining a distal portion and a proximal portion configured for grasping by a user; a second handle defining a central axis and including a gripping portion extending away from an anvil; a knife operably connected to the anvil and disposed at an inclination relative to a central axis define by of the second handle; and a drive wheel configured to operably connect to the distal portion of the first handle and to operably connect the first handle to the second handle, the drive wheel including a shaft extending away from a drive wheel head. In aspects, the first handle is configured to pivot about the shaft of the drive wheel and the second handle is configured to move relative the drive wheel head, and the distal portion of the first handle is configured to operably engage the anvil.

In other aspects, a can opening assembly for opening a can laterally is provided, the can opening assembly including a rotative assembly configured to pivot relative to a stationary assembly defining a central axis and to impart movement to a drive wheel connecting the rotative assembly to the stationary assembly, the two assemblies including respective handles and configured to operably engage a rim of the can and to make a peripheral, cut around the can upon continuous actuation of the rotative assembly during secure engagement of the can to the can opening assembly; and a knife disposed at an inclination relative to the central axis and operably connected to the stationary assembly.

In still other aspects, a method for opening a can laterally with a can opener assembly is provided, the method including positioning a can rim between a drive wheel head and an anvil, with the drive wheel head extending away from a shaft operably connected to an elongated handle in linear alignment with the shaft and configured for pivoting relative to the shaft; engaging the drive wheel and at least one drive bar connected to the anvil to the can rim; connecting the can opener assembly to the can by actuating the elongated handle in a first direction towards the can to approximate the anvil and a knife operably connected thereof to a peripheral side of the can; actuating the elongated handle in a second direction to cut the can; and providing a clean uniform cut around the peripheral side of the can.

### BRIEF DESCRIPTION OF THE DRAWINGS

The accompanying drawings, which are incorporated in and constitute a part of this specification, illustrate embodiments of the disclosure and, together with a general description of the disclosure given above, and the detailed description of the embodiments given below, serve to explain the principles of the disclosure, wherein:

FIG. 1 is a first perspective view of a can opener assembly;

FIG. 2 is a second perspective view of the can opener assembly shown in FIG. 1;

FIG. 3 is a third perspective view, perpendicular to the second perspective view in a first direction, of the can opener assembly shown in FIG. 1;

FIG. 4 is a fourth perspective view, perpendicular to the second perspective view in a second direction, of the can opener assembly shown in FIG. 1;

FIG. 5 is a perspective view of the can opener assembly shown in FIG. 1, with parts separated;

FIG. 5a is a perspective view of parts of the can opener assembly shown in FIG. 5;

FIG. 5b is a perspective view of parts of the can opener assembly shown in FIG. 5;

FIG. 6 is a perspective view of the can opener assembly shown in FIG. 1, disposed at a first position;

FIG. 6a is a perspective view of the can opener assembly shown in FIG. 6, according to line 6a-6a;

FIG. 7 is a perspective view of the can opener assembly shown in FIG. 1, disposed at a second position;

FIG. 8 is a perspective view of the can opener assembly shown in FIG. 6, with the can opener assembly engaging the can;

FIG. 9 is a perspective view of the can opener assembly shown in FIG. 7, with the can opener assembly engaging the can;

FIG. 10 is a perspective view of the can opener assembly shown in FIG. 9, opposite to the perspective view of FIG. 9 and depicting rotation of the crank;

FIG. 11 is a perspective view of a sample incision made onto a can using the can opener assembly shown in FIG. 1; and

FIG. 12 is a perspective view of a of an alternative embodiment of the can opener assembly shown in FIG. 1.

### DETAILED DESCRIPTION

Aspects of the disclosed devices and methods configured to open a can laterally while making a clean cut around a peripheral wall of the can are described in detail regarding the drawings in which like reference numerals designate identical or corresponding elements in each of the several views. As used herein the term “proximal” means close to the user and the term “distal” means more distant from the user.

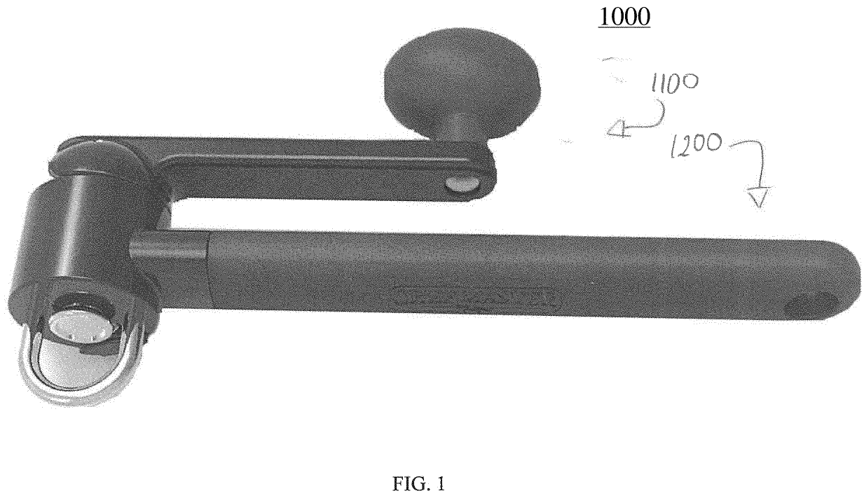

FIGS. 1-10 illustrates a laterally cutting can opener assembly 1000 (hereafter “opener assembly 1000”) including a rotatory assembly 1100 operably connected to a stationary assembly 1200. The opener assembly 1000 is configured to open a container such as a metal can (e.g., can 20, see FIG. 10), and may be configured to engage a rim (e.g., a rim 21) of a can. For example, the opener assembly 1000 is configured to pierce the can 20 laterally, e.g., the opener assembly 1000 can be configured to securely engage can 20 and to make an incision on a side thereof. Alternatively, the opener assembly 1000 may be configured to pierce a lateral side of the rim 21 (or a space defined between rim 21 and a lateral side of a can, e.g., peripheral wall 22). As best seen in FIGS. 1-4, the opener assembly 1000 is configured to securely engage at least a portion of the can 20 between a portion of rotatory assembly 1100 and a portion of stationary assembly 1200. Although shown and described with reference to can 20, the aspects of the disclosure may be modified for use with other containers, e.g., tin cans, drink cans, or rectangular or cylindrical containers substantially, e.g. a can of tuna fish.

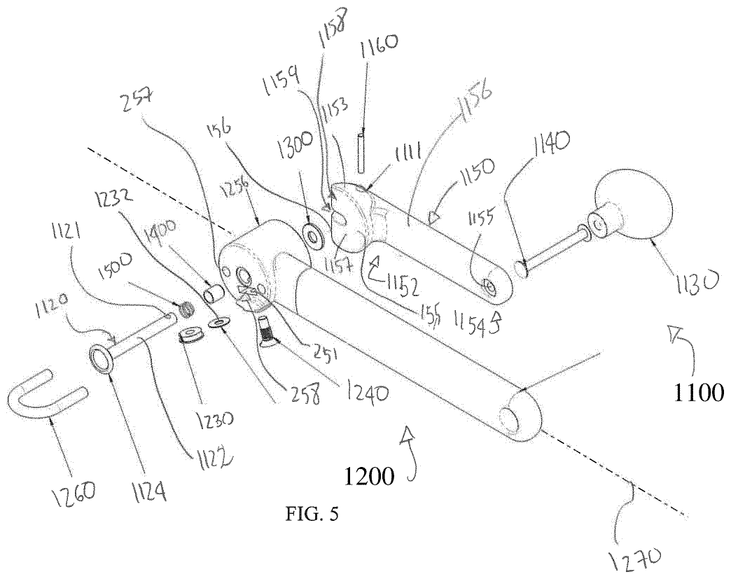

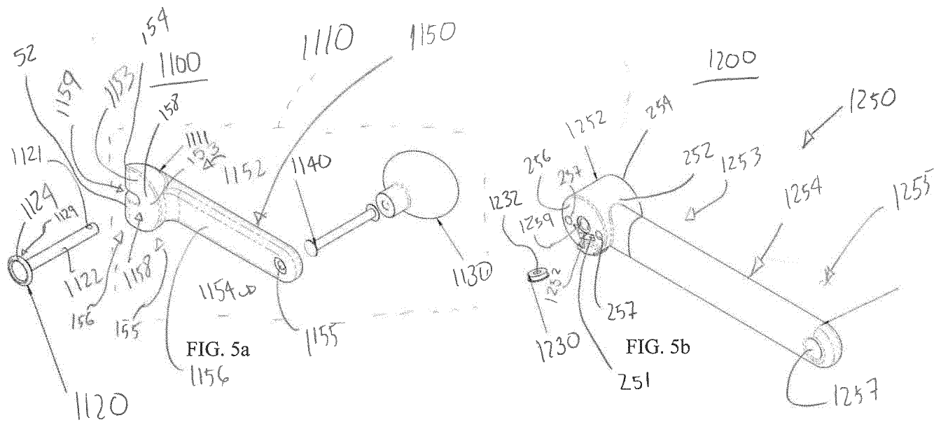

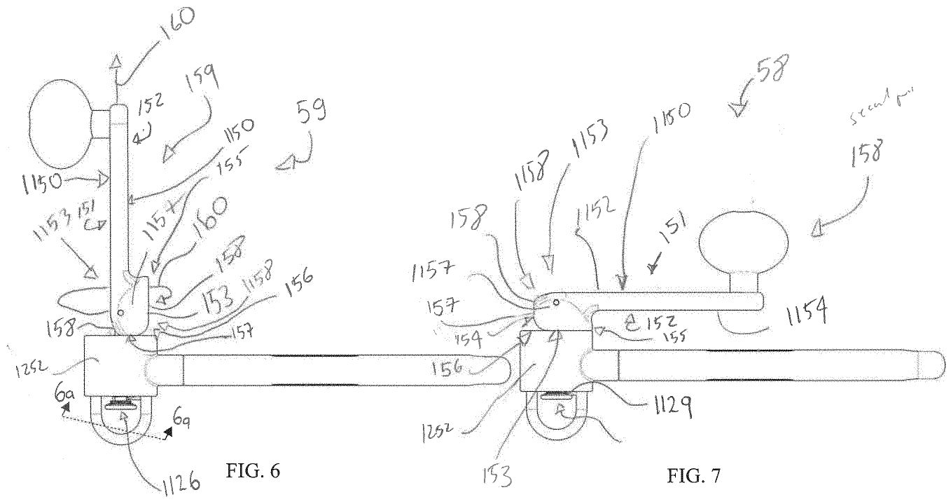

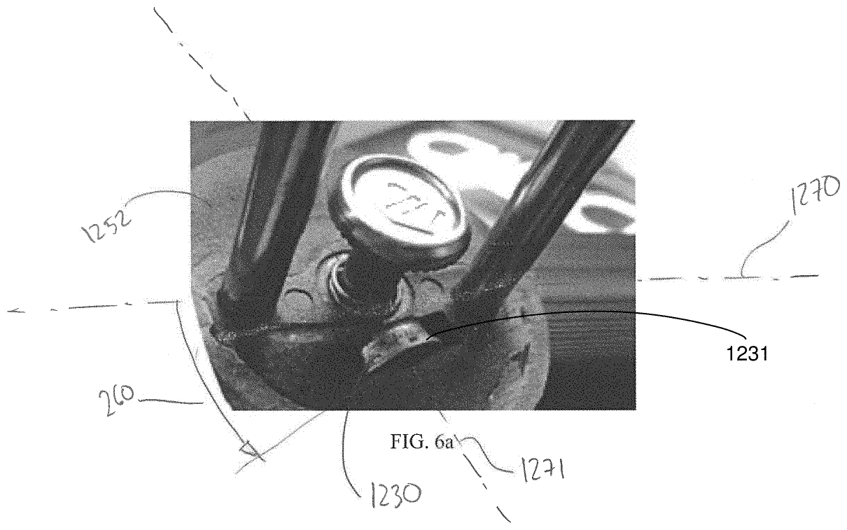

As shown in FIGS. 5-5b, opener assembly 1000 further includes a bearing 1300, a shaft collar 1400, and a resilient member 1500. The rotatory assembly 1100 (FIG. 5a) includes a crank assembly 1110 configured to operably connect to the drive wheel 1120. For example, the crank assembly 1110 includes an opening 1111 configured to be connected to an opening 1121 of the drive wheel 1120 by a first fastener 1160 (e.g., a shaft pin, FIG. 5). In other words, the first fastener 1160 is configured to engage and pass through alignable openings (e.g., opening 1111 and opening 1121) and to ultimately operably secure the drive wheel 1120 to crank assembly 1110. In general, the crank assembly 1110 is configured to pivot relative to and about the drive wheel 120, when assembled. For example, the crank assembly 1110 can swing from 0 degrees to 180 degrees (FIGS. 6 and 7) and/or swivel 360 degrees (FIG. 10), relative to an anvil 1252 of the stationary assembly 1200. Anvil 1252 is described in detail further hereinbelow.

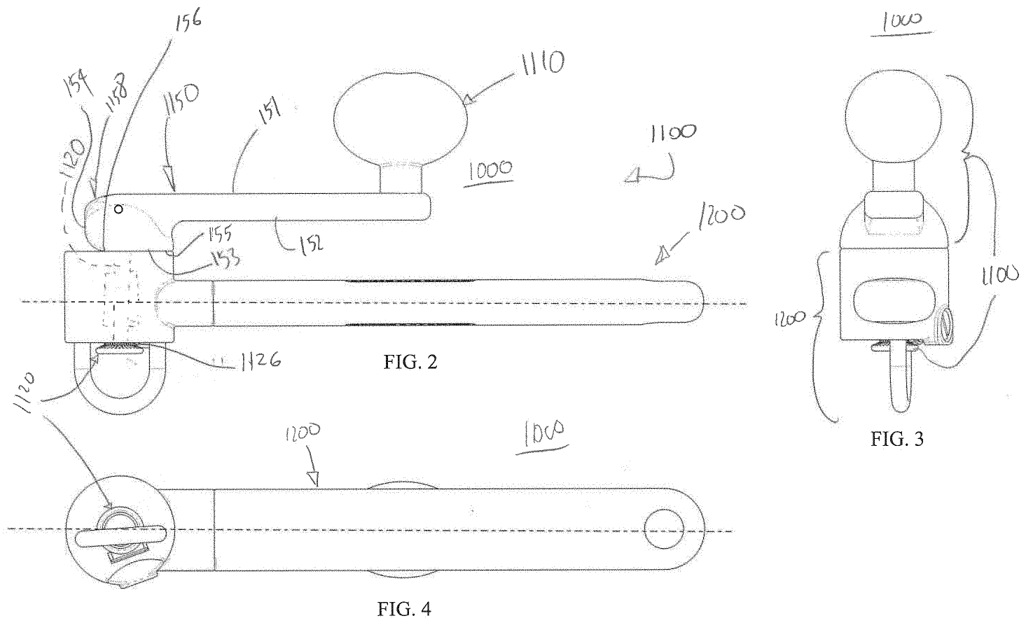

The drive wheel 1120 of the rotatory assembly 1100 is configured to operably connect the crank assembly 1110 to the stationary assembly 1200 (FIG. 2). As shown, the drive wheel 1120 includes an elongated shaft 1122 which extends away from a wheel head 1124 and is configured to operably slide through an anvil lumen 1259 of the stationary assembly 1200 (FIG. 5B). The shaft 1122 is configured to pass through the shaft collar 1400 and may be configured to pass through other elements of the assembly. For example, the elongated shaft 1122 is configured to pass through the shaft collar 1400 and the resilient member 1500 (e.g., compression spring) which may be operably connected to the drive wheel 1120 (FIG. 5).

Moreover, as illustrated in FIGS. 6 and 7, the first handle 1150 of the rotatory assembly 1100 is configured to move relative to the stationary assembly 1200. For example, the first handle 1150 can be configured to pivot relative to the anvil 1252 and/or the drive wheel shaft 1122. As shown, first handle 1150 is configured to at least rotate clockwise and counterclockwise directions relative to anvil 1252, about the drive wheel 1120. In addition, the first handle 1150 is configured to at least pivot between 0 and 180 degrees, e.g., the first handle 1150 pivoting from a substantially flat position (e.g., 0 degrees relative to the anvil 1252, FIG. 7) to a perpendicular position (e.g., 90 degrees relative to the anvil 1252, FIG. 6).

The crank assembly 1110 of the rotatory assembly 1100 includes a first handle 1150 defining a distal end 1152 configured to engage the stationary assembly 1200 and a proximal end 1154 configured to operably connect to a crank knob 1130. Further, the first handle 1150 defines a first side 151 and second side 152 opposing the first side 151. For example, the distal end 1152 includes a head 1153 configured to engage the anvil 1252 of the stationary assembly 1200, and the proximal end 1154 includes an opening 1155 configured to receive a binding post 1140 which is configured to operably connect the crank knob 1130 to the first handle 1150. The crank knob 1130 of the rotatory assembly 1100 is configured to be grasped by a human hand and is shown including, but not limited to, an ovoid body resembling an egg in shape. The first handle 1150 of rotatory assembly 1100 includes an elongated first grasping portion 1156 extending away from the head 1153 and configured for grasping by a human hand. As shown, the elongated first grasping portion 1156 and the head 1153 are monolithically formed. Alternatively, the elongated first grasping portion 1156 may be operably connected to the head 1153.

The head 1153 of the rotatory assembly 1100 is configured to operably connect to the drive wheel 1120 and to engage the anvil 1252. For example, the head 1153 defines a head body 1157 including a pivoting portion 1158, a recess 1159 (FIG. 5a) configured to receive the drive wheel 1120 or at least a portion thereof (e.g., a portion of the shaft 1122). The pivoting portion 1158 of the rotatory assembly 1100 defines an engaging surface 1158 configured to operably engage the anvil 1252 of the stationary assembly 1200. For example, the engaging surface 158 is configured to engage the anvil 1252 at least when the can opener assembly 1000 is disposed first engagement position (e.g., position 59, FIG. 6) and at least when the can opener assembly 1000 is disposed at a second engaging position (e.g., position 58, FIG. 7). As shown, the engaging surface 158 is disposed at the end 1152 wrapping around a portion of the body 1157 from the first side 151 to the second side 152. The engaging surface 158 includes a pivoting flat portion 153 (hereafter “flat portion 153”) and a pivoting curved portion 154 (hereafter “curved portion 154”). The flat portion 153 is substantially flat with a U-shape and defines a flat portion proximal end 155 and a flat portion distal end 156 (best seen in FIG. 5a). The curved portion 154 of the engaging surface 158 extends away from the flat portion distal end 156 of flat portion 153 and wraps around a distal tip 152 of the distal end first handle 1150.

During operation, flat portion 157 is configured to engage the stationary assembly 1200 at least during disposal of the drive wheel 1120 at a second drive wheel position 1126 (FIG. 6) and during rotation of the first handle 1150 in a clockwise or counter-clockwise direction (e.g., as illustrated in FIG. 10). The curved portion 154 is configured to engage the anvil 1252 of the stationary assembly 1200 at least during manipulation of the first handle 115. As shown, the flat portion 157 of the curved portion 154 is substantially flat and is configured to operably engage the anvil 1252 at least during transition of the first handle 1150 from a position to another with respect to the anvil 1252, e.g., when the first handle 1150 transitions from position 59 (FIG. 6) to position 58 (FIG. 7) during disposal of rim 21 of can 20 between the drive wheel 1120 and the anvil 1252. Further, the curved portion 154 of the first handle 1150 may disengage from stationary assembly 1200 if the first handle 1150 is pulled in direction 160 (FIG. 6), when the handle 1150 is substantially aligned with the drive wheel 1120.

The stationary assembly 1200 of the can opener assembly 1000 includes a knife 1230 (FIGS. 5 and 6b) operably connected to a second handle 1250 including a second grasping portion 1254 extending away from the anvil 1252. As shown, the anvil 1252 and the second grasping portion 1254 are operably connected. Alternatively, the anvil 1252 and the second grasping portion 1254 may be monolithically formed. The second grasping portion 1254 of the stationary assembly 1200 is configured to be grasped by a human hand and defines a second grasping portion distal end 1253 (hereafter “first end 1253”) configured to connect to the anvil 1252 and a second grasping portion second end 1255 (hereafter “second end 1255”). As shown in FIG. 5b, the proximal end 1255 may further include an opening 1257 which may be use for handling and/or putting away the opener assembly 1000 (e.g., opening 1257 may be used to hang the opener assembly 1000 to a nail attached to a wall).

As shown, the anvil 1252 of the stationary assembly 1200 is configured to operably connect to drive wheel 1120 and to operably connect to the knife 1230. As shown, the anvil 1252 is configured to receive the drive wheel 1120 therethrough. For example, the anvil 1252 is cylindrical and defines an anvil lumen 1259 configured to operably receive the shaft 1122 of the drive wheel 1120, the anvil lumen 1259 communicates two sides of the anvil 1252. The anvil 1252 defines a peripheral side 252 disposed between a crank engaging side 254 and a can engaging side 256 opposing the crank engaging side 254, the crank engaging side 254 and the can engaging side 256 communicate by the central anvil lumen 1259. As shown, the peripheral side 252 is configured to connect to the second grasping portion 1254 and the crank engaging side 254 is configured to engage the head 1153 of the rotatory assembly 1100.

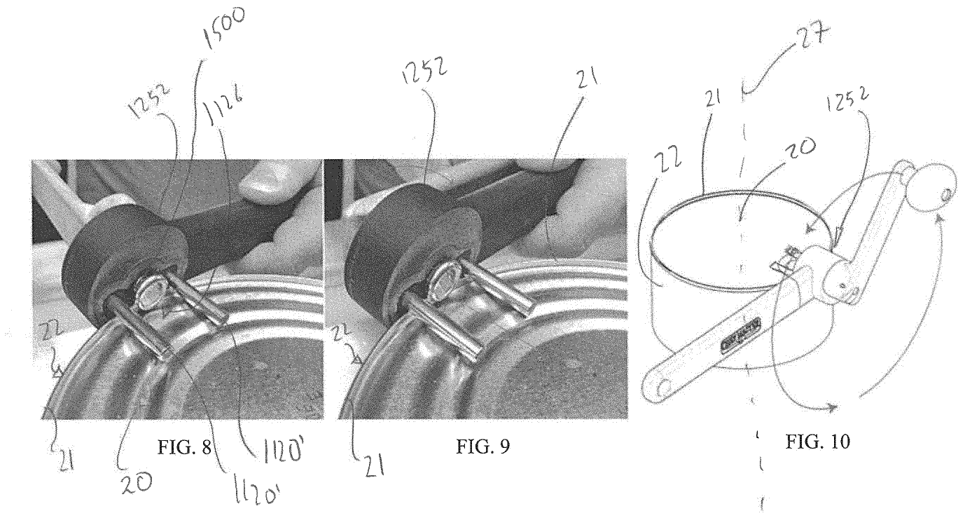

As noted above, the anvil 1252 of the second handle 1250 is configured to connect to the knife 1230 and to facilitate manipulation of the can 20 relative to the opener assembly 1000, thus, may include elements that can aid with positioning of the can 20 relative to the second handle 1250 and elements that may aid connecting the knife 1230 to the anvil 1252. For example, the anvil 1252 includes a knife pocket 258 configured to receive the knife 1230 and at least one opening 257 configured to receive a guide bar 1260. Alternatively, the guide bar 1260 may be configured as protrusions monolithically formed with an anvil (e.g., anvil 1252) extending away from a can engaging side (e.g., can engaging side 256). As shown, the knife pocket 258 is a cavity disposed at the can engaging side 256 at an angle 206 (FIG. 6a) relative to a central axis 1270 defined by the second handle 1250 (FIGS. 5 and 6a). As shown, the anvil 1252 includes the central anvil lumen 1259 disposed between two openings 257 and with each one of the two openings 257 configured to receive the guide bar 1260; the two openings 257 and the central anvil lumen 1259 are substantially in linear alignment with the central axis 1270 (FIG. 6a). Alternatively, the anvil 1252 may be configured to be connected to two guide bars 1120′ (FIGS. 8-10).

As shown in FIGS. 1-7, the guide bar 1260 of the stationary assembly 1200 is U-shaped and is configured to engage the can during operation of the opener assembly 1000. Alternatively, the guide bar 1260 may be elongated or another suitable shape. For example, the guide bar 1260 may be elongated parallel bars protruding away from an anvil (e.g., anvil 1252) as illustrated in FIGS. 8 and 9.

The knife 1230 of the stationary assembly 1200 is configured to connect to the anvil 1252. For example, the anvil 1252 may include elements than can enable secure engagement of the knife 1230 to the portion 210, e.g., a pocket channel 251 (FIGS. 5 and 5b) connecting the peripheral side 252 of the anvil 1252 with the knife pocket 258 and configured to receive a second fastener 1240 (FIG. 5). As shown, the knife 1230 is cylindrical and includes a knife lumen 1232 configured to receive at least a portion of second fastener 1240 (therethrough). The second fastener 1240 may be a connector configured to operably connect or fix the knife 1230 to the anvil 1252. As shown, the second fastener 1240 is a screw configured to enable free rotation of the knife 1230 around a second axis 1271 defined by the anvil 1252. Although shown and described with reference knife 1230 and anvil 1252 the aspects of the disclosure may be modified for use with alternative knives (e.g., knifes having a rectangular or triangular shape) and/or with alternative anvil portions (e.g., an anvil portion not having a knife pocket). Furthermore, the knife 1230 may configured to enable a smooth cut around can 20. For example, edge 1231 (FIG. 6a) of the knife 1230 may be a sharp edge, which may enable a cut having an even and regular surface or consistency; free from perceptible projections, lumps, or indentations.

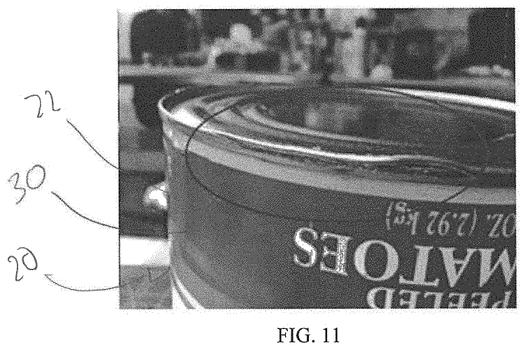

FIGS. 8-10 illustrates the opener assembly 1000 engaging the can 20 during operation. As shown, the opener assembly 1000 is configured to engage at least the rim 21 and the peripheral wall 22 of the can 20 and to further manipulate the engaged can 20. For example, the opener assembly 1000 engages the rim 21 when disposed between the anvil 1252 and the drive wheel head 1252 (FIGS. 8-10). In FIG. 8, at the first drive wheel position 1126 (FIGS. 8), the knife 1230 may not engage the can 20 and the resilient member 1500 may be at an extended position. The resilient member 1500 is configured to aid displacing the rotatory assembly 1100 relative of the stationary assembly 1200 or the stationary assembly 1200 relative to the rotatory assembly 1100. For example, the resilient member 1500 may aid with retention of the drive wheel 1120 (when disposed away of the can 20) and/or at least when the first handle 1150 is at the first position 159 (FIGS. 6 and 8). To further manipulate the can 20, the opener assembly 1000 is configured to securely rotate the can 20 while avoiding disengagement of the knife 1230 with the peripheral wall 22 (of at least a portion on rim 21) of the can 20 and the drive wheel head 1124 with the rim 21. For example, the knife wheel 1124 may include engaging features or elements (e.g. wheel teeth 1128, FIG. 2) configured to engage the can rim 21. As shown, the wheel teeth 1128 are serrated or scalloped and are disposed onto the drive wheel head 1124 along an inner wall 1129 (FIGS. 5a and 7). During secure engagement of the wheel teeth 1128 to the rim 21 of the can 20 and with the first handle 1150 disposed substantially parallel to the first handle 1150, the knife 1230 makes an incision (e.g. incision 30, FIG. 11) on the peripheral wall 22 during cranking of the rotatory assembly 110 (e.g., rotation of the crank assembly 1110 in a clockwise direction). Prior to cranking of the rotatory assembly 200 in a direction parallel to the second handle 1250, and during engagement of the can 20 with the opener assembly 1000, the knife 1230 may pierce the peripheral wall 22 of the can 20.

During operation, the crank assembly 1110 is configured to enable displacement of the drive wheel 1120 relative to the anvil 1252. For example, as shown in FIG. 8, at position 59, the crank assembly 1110 is disposed at 90 degrees relative to the second handle 1250 with the drive wheel head 1124 of the drive wheel 1120 extended away from the anvil 1252. As shown in FIG. 8, at the second position 158, the crank assembly 1110 is disposed parallel to the second handle 1250 and the drive wheel head 1124 is disposed closer to the anvil 1252 when compared to the first position 159. The crank assembly 1110 may be configured to extend 180 degrees relative to the second handle 1250. In embodiments, the opener assembly 1000 may be configured to disengage from the can 20 by rotating the crank assembly 1110 in a direction opposing a direction of cutting (e.g. counterclockwise direction). For example, a user may engage the rim 21 of the can 20 between the anvil 1252 of stationary assembly 1200 and the wheel head 1124 of rotatory assembly 1100, bring the crank assembly 1110 and the second handle 1250 together or until about parallel with the second handle 1250 while exerting a pressure force onto the rim 21 and the peripheral wall 22, turn the crank assembly 1110 in a clockwise direction to initially cut the peripheral wall 22 by the engagement of the knife 1230 thereof, and may turn the crank assembly 1110 in a counter-clockwise direction to disengage the opener assembly 100 from the can 20. In another example, the user may open can 20 by engaging the rim 21 of the can 20 between the anvil 1252 and the wheel head 1124, displace the first handle from a 12 o′clock position to a 3 o′clock position to displace the wheel head 1124 (or the second handle 1250) towards the rim 21 and ultimately engage the knife 1230 with the peripheral wall 22 (or a portion of the can 20 where the rim 21 and the peripheral wall 22 meet), and rotate the crank assembly 1110 on a clockwise direction to enable displacement of the can 20 relative to the opener assembly 1000 while making an incision on the can 20 via the knife 1230. During secure engagement of the can opener assembly 1000, a force is created between a portion of the drive wheel 1120 (e.g., wheel teeth 1126, FIG. 2) and the can rim 21 which may enable movement of the can 20. For example, a frictional force during rotation of the first handle 1150 (e.g., rotation in a clockwise direction about central anvil lumen 1259) which enables displacement of the can 20 (e.g., the can 20 rotates about a can's central axis 27 in an opposite direction of the rotation of the first handle 1150, FIG. 10).

In embodiments, the opener assembly 1000 may be configured to further include or store an additional element (e.g., a second knife). For example, the crank assembly 1110 or the second handle 1250 may include a second pocket (not shown) configured to receive a spare knife.

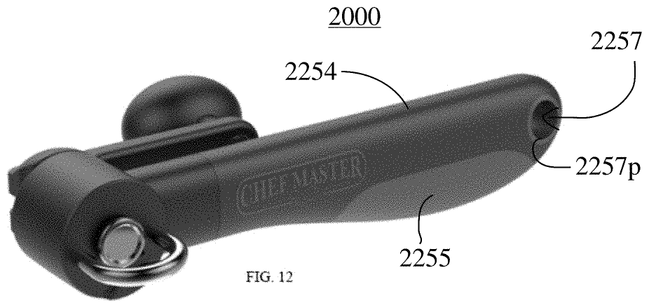

With reference to FIG. 12, an alternative embodiment of the opener assembly 1000 is presented as opener assembly 2000. For reasons of brevity, only selected differences between the opener assembly 2000 and the opener assembly above are detailed below.

The opener assembly 2000 includes a grasping portion 2254 which is elongated and an ergonomic portion 2255. The ergonomic portion 2255 is generally connected to the grasping portion 2254 or can be monolithically formed (e.g., molded) with the grasping portion 2254. When connected to the grasping portion 2254, the ergonomic portion 2255 may be constituted of a material similar or different to the material of the ergonomic portion 2255. For example, the grasping portion 2254 may be constituted of a material softer than a material used to manufacture the grasping portion 2254. As shown, the grasping portion 2254 is made out of a polymer (e.g., heat resistant rubber, ruggedized plastic, or a silicon material) which may be slightly resilient and is shaped to be ergonomically grasped by a human user (e.g., shaped to fit on a human hand). Further the grasping portion 2254 includes an opening protecting portion 2257p generally disposed within an opening 2257 (similar to opening 1257). In embodiments, the opening protecting portion 2257p may be constituted of a material similar to the material used to manufacture the ergonomic portion 2255. As shown, the opening protecting portion 2257 is connected to the opening 2257 as shown in FIG. 12. The opening 2257 is configured to aid in the handling of the opener assembly 2000 (e.g., opening 2257 may be used to put away the opener assembly 2000, e.g., the opening 2257 can receive a nail (not shown) attached to a wall if a user desires to hang the opener assembly 2000 therefrom and the opening protecting portion 2257p is configured to prevent wear of the opening 2257.

Persons skilled in the art will understand that the devices and methods specifically described herein and illustrated in the accompanying drawings are non-limiting exemplary aspects. It is envisioned that the elements and features illustrated or described in connection with the exemplary aspects may be combined with the elements and features of another without departing from the scope of the disclosure. As well, one skilled in the art will appreciate further features and advantages of the disclosure based on the above-described aspects. Accordingly, the disclosure is not to be limited by what has been particularly shown and described, except as indicated by the appended claims.

What is claimed is:

1. A lateral-cutting can opener assembly configured to pierce and make a continuous incision on a peripheral can wall or a peripheral rim wall, the lateral-cutting can opener assembly comprising:
a first handle defining a distal portion and a proximal portion configured for grasping by a user;
a second handle defining a central axis and including a gripping portion extending away from an anvil;
a knife operably connected to the anvil and disposed at an inclination relative to a central axis define by of the second handle; and
a drive wheel configured to operably connect to the distal portion of the first handle and to operably connect the first handle to the second handle, the drive wheel including a shaft extending away from a drive wheel head,
wherein the first handle is configured to pivot about the shaft of the drive wheel and the second handle is configured to move relative the drive wheel head, and
wherein the distal portion of the first handle is configured to operably engage the anvil.

2. The lateral-cutting can opener assembly of claim 1, further including at least one guide bar defining two ends and at least one of the ends selected from the two ends is configured to connect to the anvil.

3. The lateral-cutting can opener assembly of claim 2, wherein the guide bar is a U shape or configured as elongated straight bars.

4. The lateral-cutting can opener assembly of claim 2, wherein the at least one guide bar is disposed perpendicular to a surface of the anvil.

5. The lateral-cutting can opener assembly of claim 2, wherein the two ends of the guide bar is disposed along the central axis of the second handle.

6. The lateral-cutting can opener assembly of claim 1, wherein the anvil further includes a lumen configured to receive the shaft of the drive wheel.

7. The lateral-cutting can opener assembly of claim 6, wherein the lumen is configured to receive a spring configured to encompass the drive wheel shaft.

8. The lateral-cutting can opener assembly of claim 6, wherein the shaft of the drive wheel is configured to operably slide along the lumen during manipulation of the first handle relative to the second handle.

9. The lateral-cutting can opener assembly of claim 1, where in the first handle is configured to move at least between a first position and a second position.

10. The lateral-cutting can opener assembly of claim 9, wherein the first position includes the first handle in linear alignment with the drive wheel, the first and second handles defining an angle of about 90 degrees between the two and the drive wheel head of the drive wheel disposed away from the anvil.

11. The lateral-cutting can opener assembly of claim 10, wherein the second position includes the first handle and the drive wheel defining an angle of about 90 degrees between the two and the drive wheel head of the drive wheel disposed closer to the anvil when compared to a position of the wheel head at the first position.

12. The lateral-cutting can opener assembly of claim 1, wherein the first handle is configured to at least rotate between 0 and 180 degrees and rotate 360 degrees in a clockwise or counter-clockwise direction, relative to the drive wheel or the anvil.

13. The lateral-cutting can opener assembly of claim 6, wherein the lumen is configured to meet the central axis.

14. The lateral-cutting can opener assembly of claim 13, wherein the lumen is disposed perpendicular to the central axis.

15. The lateral-cutting can opener assembly of claim 1, wherein the anvil further includes a pocket configured to receive the knife.

16. The lateral-cutting can opener assembly of claim 1, wherein the knife and a can wall different from the peripheral can wall define an angle between 0 and 50 degrees during secure engagement of the can to the lateral-cutting can opener.

17. The lateral-cutting can opener assembly of claim 1, wherein the knife is a replaceable knife.

18. The lateral-cutting can opener assembly of claim 1, wherein the knife is operably connected to the anvil and disposed at an inclination between 180 and 230 degrees relative to the central axis of the handle.

19. A can opening assembly for opening a can laterally, the can opening assembly comprising:
a rotative assembly configured to pivot relative to a stationary assembly defining a central axis and to impart movement to a drive wheel connecting the rotative assembly to the stationary assembly, the two assemblies including respective handles and configured to operably engage a rim of the can and to make a peripheral, cut around the can upon continuous actuation of the rotative assembly during secure engagement of the can to the can opening assembly; and
a knife disposed at an inclination relative to the central axis and operably connected to the stationary assembly.

20. A method for opening a can laterally with a can opener assembly, the method comprising:
positioning a can rim between a drive wheel head and an anvil, with the drive wheel head extending away from a shaft operably connected to an elongated handle in linear alignment with the shaft and configured for pivoting relative to the shaft;
engaging the drive wheel and at least one drive bar connected to the anvil to the can rim;
connecting the can opener assembly to the can by actuating the elongated handle in a first direction towards the can to approximate the anvil and a knife operably connected thereof to a peripheral side of the can;
actuating the elongated handle in a second direction to cut the can; and
providing a clean uniform cut around the peripheral side of the can.

21. The method of claim 20, further comprising operably securing the opener assembly to the can after connecting the opener assembly to the can by initiating rotation of the crank in the second direction.

22. The method of claim 21, further comprising defining an angle of about 90 degrees between the knife and the elongated handle and rotating the elongated handle in the second direction selected from clockwise or counter-clockwise direction, during opening of the can, and rotating elongated handle in a direction opposing the second direction to disengage the can opener assembly from the can, during or after the opening of the can.
